(19) United States
(12) Patent Application Publication
(10) Pub. No.: US 2003/0169807 A1
(43) Pub. Date: Sep. 11, 2003

(54) Method for transmitting an analog data stream with sampling rate increase in the data stream transmitter, and a circuit arrangement for carrying out this method

(76) Inventor: Dietmar Straeussnigg, Villach (AT)

Correspondence Address: STEVEN B. PHILLIPS, MOORE & VAN ALLEN, SUITE 800, 2200 WEST MAIN STREET, DURHAM, NC, 27705, US

(21) Appl. No.: 10/374,951

(22) Filed: Feb. 26, 2003

(30) Foreign Application Priority Data
Feb. 28, 2002 (DE) 102 08 717.2

(51) Int. Cl. H04B 1/38; H04L 5/16; H04K 1/10

(52) U.S. Cl. 375/222; 375/260; 375/295

(57) ABSTRACT

Method for transmitting an analog data stream with sampling rate increase in the data stream transmitter, and a circuit arrangement for carrying out the method

The invention provides a method for transmitting an analog data stream (101), which is composed of discrete multitone symbols (208), from a data stream transmitter (214) via a transmission channel (102) to a data stream receiver (215), interpolation between successive samples of a supplied multitone signal (303) being carried out in an interpolation device (109) of the data stream transmitter (214), amd coded data blocks (125) which are generated by means of a coding device (202) from data (123) to be transmitted being inversely transformed from the frequency domain into the time domain in conjunction with a number of carriers, increased by comparison with an ADSL Standard, in an inverse transformation device (203) of the data stream transmitter (214).

Method for transmitting an analog data stream with sampling rate increase in the data stream transmitter, and a circuit arrangement for carrying out the method

The present invention relates to a method for transmitting an analog data stream according to the preamble of patent claim 1, and relates, in particular, to a method for transmitting an analog data stream which is composed of discrete multitone signals.

In known methods for transmitting an analog data stream which is composed of discrete multitone symbols, a sampling rate increase (interpolation) is carried out in the data stream transmitter, while a corresponding sampling rate reduction (decimation) is carried out in the associated data stream receiver in order in each case to achieve efficient conversions of the signals from the digital into the analog domain (D/A conversion) or, vice versa, from the analog into the digital domain (A/D conversion).

The present invention relates to operations in the data stream transmitter, that is to say in particular to a sampling rate increase in the data stream transmitter in the case of DMT (Discrete Multitone) systems, avoiding image frequencies.

An interpolation in the data stream transmitter in the conventional way by inserting zeros between successive samples, and subsequent lowpass filtering [sic].

The first step below is to describe the principle of analog data stream transmission by means of a multitone system.

It is normal to make use of a multitone method (DMT, Discrete Multitone, discrete multitone modulation) for asymmetric data stream transmission via conventional telephone lines, conventional telephone lines being constructed as asymmetric digital subscriber lines (ADSL=Asymmetric Digital Subscriber Line).

A substantial advantage of ADSL transmission techniques consists in that conventional cable networks can be utilized for transmission, it being normal to use twisted-together copper wire pairs.

High-speed digital subscriber lines according to the prior art are described, for example, in the publication “High-speed digital subscriber lines, IEEE Journal Sel. Ar. In Comm., Vol. 9, No. 6, August 1991”.

Different VDSL (Very High Data Rate DSL (=Digital Subscriber Line)) arrangements are known among the transmission methods with a high data rate based on digital subscriber lines, it being possible for this purpose to use, for example, methods such as CAP (Carrierless Amplitude/Phase), DWMT (Discrete Wavelet Multitone), SLC (Single Line Code) and DMT (Discrete Multitone). In the DMT method, the transmitted signal is prepared from multiple sinusoidal and/or cosinusoidal signals, it being possible for each individual sinusoidal or cosinusoidal signal to be modulated both in amplitude and in phase. The multiply modulated signals thus obtained are provided as quadrature-amplitude-modulated signals (QAM=Quadrature Amplitude Modulation).

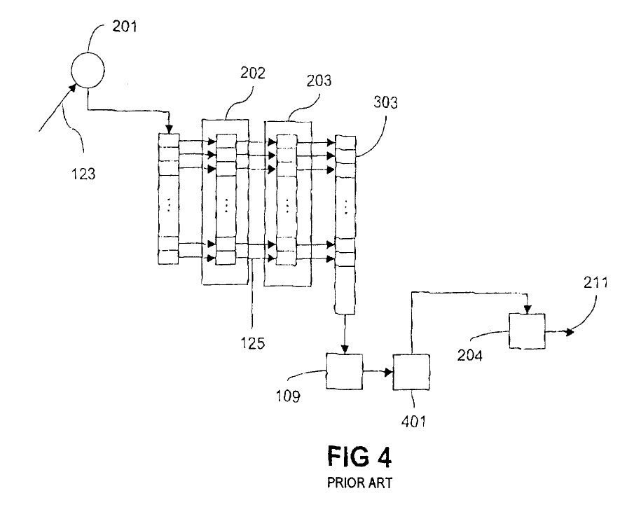

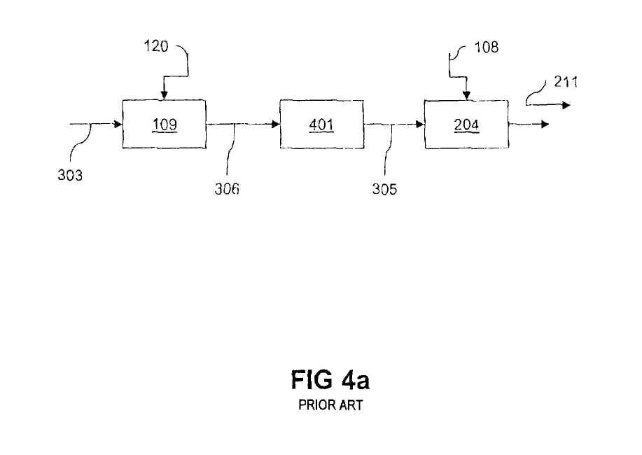

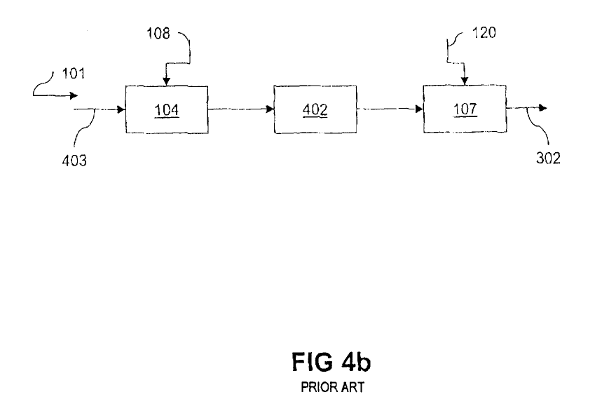

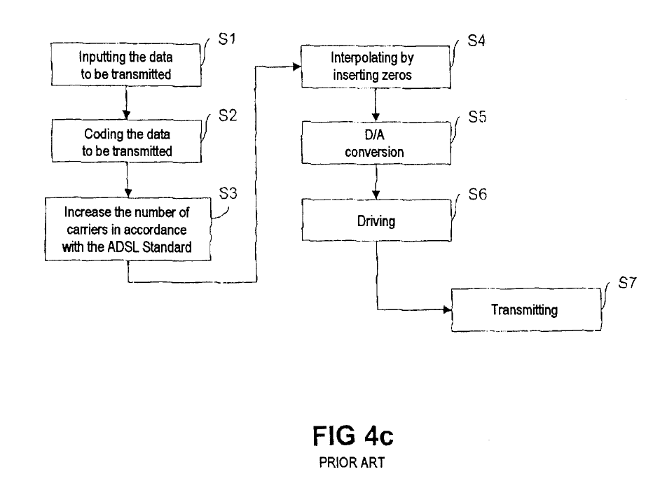

Shown in FIG. 4 is a conventional data stream transmitter in which data 123 to be transmitted are input via a data input device 201. The data 123 to be transmitted are supplied to a coding device 202 in which the data are firstly coded and subsequently combined to form coded data blocks 125, a prescribable number of bits to be transmitted being assigned to a complex number depending on scaling. Finally, the coded data blocks 125 output by the coding device 202 are supplied to an inverse transformation device 203.

The inverse transformation device 203 conventionally uses an inverse fast Fourier transformation (IFFT) to transform the data present in the frequency domain into the time domain for a number of carriers (32 for the ADSL upstream channel) prescribed by the ADSL Standard, for example, N samples of a transmitter signal being generated directly from N/2 complex numbers, all N samples being denoted below as a discrete multitone symbol (DMT symbol; DMT=Discrete Multitone). In this case, the complex numbers can be provided as amplitude values of cosinusoidal and sinusoidal oscillations (real part and imaginary part) to be emitted within a data block, the frequencies being distributed equidistantly in accordance with the relationship:

$${f}_{i} = i \cdot \frac{1}{T} i = 1 , 2 , … N / 2.$$

In this case, T denotes a time duration for transmitting a discrete multitone symbol, and N denotes a number of samples for a discrete multitone symbol.

For example, conventional ADSL-DMT methods make use in a downstream mode, that is to say in the case of data transmission from at least one exchange to at least one subscriber, of 256 tones which can each be modulated as sinusoidal tones in absolute value and phase. The fundamental frequency is 4.3 kHz in this case, and the frequency spacing between successive tones is likewise 4.3 kHz. A frequency spectrum from 4.3 kHz (fundamental frequency) to (4.3 kHz+256×4.3 kHz)=1.1 MHz is therefore transmitted. Each DMT symbol is therefore represented by a sinusoidal tone which can be modulated in absolute value and phase, at most 15 bits per symbol normally being represented as complex number. In the case of transmission of a multitone signal constructed in this way, however the problem arises that the transmission channel, which can be constructed, for example, as a twisted copper two-wire line, causes transient phenomena which have decayed after M samples, for example.

After an inverse fast Fourier transformation, the last M samples of a DMT symbol are appended in the transmitter device to a block start, the relationship M<N applying. Through this cyclic expansion (cyclic prefix), a periodic signal can be simulated to the data stream receiver when the transient phenomenon caused by the transmission channel has decayed after M samples, it being possible to avoid mutual disturbance by different DMT symbols, that is to say intersymbol interference (ISI).

It is thereby possible in conventional methods substantially to reduce outlay on equalization in an equalization device which is arranged in the data stream receiver, since after demodulation of the receiving analog data stream 101 in the data stream receiver it is necessary only to undertake a simple correction in the correction device 112 with the aid of the inverse frequency response of the transmission channel.

A substantial disadvantage of data transmission using the ADSL method via copper lines, in the case of which multitone signals are transmitted, consists in the occurrence of long transient phenomena. Consequently, the cyclic prefix is conventionally expanded in order to supply a periodic signal to the data stream receiver. However, the cyclic prefix must be kept small in relation to the DMT symbol length N, that is to say the following relationship must be valid:

M<<N,

since otherwise there is a disadvantageous reduction in the transmission capacity.

In the ADSL Standard, provision is made, for example, for a DMT symbol length of N=64 and a value of M=4 for a cyclic prefix, in order to transmit data from a subscriber to an exchange. In order to limit a transient phenomenon to the cyclic prefix, use is made in the case of the known method in the preprocessing device, which is arranged in the data stream receiver, of a special equalizer for the time domain (TDEQ=Time Domain Equalizer) in the form of an adaptive transversal filter which operates at a symbol rate Fs (for example 276 kHz in the exchange in the case of ADSL).

As mentioned above, owing to the required limitation of the length of the cyclic prefix to M=4, for example, in conventional methods for transmitting an analog data stream 101 there is a disadvantageous worsening of the transmission quality, since substantial intersymbol interference (ISI) is present even when an equalizer is used in the data stream receiver.

A conventional transmission channel further disadvantageously contains highpass and lowpass filters in order to limit the bandwidth of the analog data stream to be transmitted, and in order to suppress outband noise in analog-to-digital and digital-to-analog converters which can be constructed, for example, as sigma-delta converters.

In particular, it is disadvantageous that during excitation of lowpass filters with the aid of DMT signals transient phenomena occur which have substantial spectral components in a frequency domain above the transmission signal band provided. For example, given a sampling rate Fs of 276 kHz, convolutional products in the transmission signal band produce spectral components which cannot be eliminated from the equalizer arranged in the data stream receiver. These convolutional products are disadvantageously contained in the transmission signal band as interfering signals, as a result of which a transmission quality is worsened.

In accordance with FIG. 4, a multitone signal generated in the time domain is subsequently transmitted in the form of DMT symbols. In order to provide an analog transmitter signal 211, an analog-to-digital converter 104 is provided for converting from a digital multitone signal 303 into the analog transmitter signal 211.

FIG. 4a illustrates as [sic] a detailed view of a transmitter filtering device 401 which is normally arranged in the data stream transmitter. A multitone signal 303 which has a sequence of discrete multitone symbols 208 is supplied to an interpolation device 109. Applied to the interpolation device 109 is a symbol rate 120 which, inter alia, fixes a data transmission rate. The interpolated multitone signal 306 output by the interpolation device 109 is supplied to the transmitter filtering device 401. The transmitter filtering device 401 is provided by a highpass filter, a lowpass filter and/or a combination of at least one highpass filter and at least one lowpass filter. The filtered signal output by the transmitter filtering device 401 is finally supplied to the digital-to-analog converter 204 as a filtered multitone signal 305. The digital-to-analog converter 204 operates at a prescribed sampling rate 108, in order, as also described with reference to FIG. 4, to convert the digital, filtered multitone signal 305 into an analog data stream 211 to be transmitted.

The data are further processed in a data stream receiver after transmission of the data stream to be transmitted via a transmission channel.

FIG. 4b shows the essential components of a preprocessing device of a data stream receiver in a block arrangement. An analog data stream transmitted via the transmission channel and which is composed of multitone symbols is filtered in the data stream receiver in the form of received data 403 in a receiver filtering device 402. For this purpose, the received data 403 are firstly supplied to an analog-to-digital converter 104 which samples the analog data stream at a sampling rate 108 which is identical to the sampling rate represented in the data stream transmitter 214.

The received data stream digitized in the analog-to-digital converter 104 is supplied to a receiver filtering device 402 in which the digitized, received data are filtered.

It may be pointed out that, just as in the transmitter filtering device 401, there can also be contained in the receiver filtering device 402 highpass filters, lowpass filters and/or a combination of highpass filters and lowpass filters.

The filtered digital data stream is supplied to a decimation device 107 to which the symbol rate 120 which has already been mentioned with reference to FIG. 4a is applied. The decimated data are output as a preprocessed, digital data stream 302 and further processed in the data stream receiver.

A disadvantage of conventional transmitter filtering devices consists in that there occur during an interpolation process in digital multitone systems transient phenomena which are combined as an additive superimposition of two constituents, that is to say as a superimposition of transient phenomena caused by the transmission line and by transients as a consequence of the non-vanishing storage values.

Since a conventional transmission channel contains highpass filters and/or lowpass filters for band limitation, which are also used to suppress outband noise in the case of analog-to-digital converters and digital-to-analog converters (for example sigma-delta (Σ-Δ) converters), lowpass filters, in particular, are excited with the aid of digital multitone signals in such a way that transient phenomena occur which are caused by storage values which have a non-vanishing value. In the frequency domain, these transient phenomena have substantial spectral components above the actual transmission band and are disadvantageously extremely difficult to handle, particularly given a short cyclic prefix (4 in the example described here).

A corresponding problem occurs in the data stream receiver when transient phenomena are generated by non-vanishing storage values (for example memory contents). Convolutional products which are composed in the case of digital multitone systems as an additive superimposition of three essential constituents:

(i) a noise component,

(ii) transient phenomena (transmission channel), and

(iii) transients owing to the memory contents or storage values of the filtering device,

occur during the decimation process, which is provided in the data stream receiver and is carried out, in particular, by the decimation device.

For a further explanation of a conventional data stream transmission method, reference is made to FIG. 4c as an overview of the individual conventional method steps.

The data stream 123 to be transmitted is input in a step S1. The input data stream is finally coded (step S2), a number of carriers corresponding to an ADSL Standard subsequently being set (step S3). For the purpose of interpolating and/or increasing the sampling rate, zeros are now inserted in step S4 in order efficiently to provide the subsequent digital-to-analog conversion in step S5.

After the efficient digital-to-analog conversion, in step S6 the analog data stream to be transmitted is driven into the transmission channel, and the analog data stream to be transmitted is subsequently transmitted in a conventional way in step S7.

This conventional method for transmitting an analog data stream composed of discrete multitone symbols, and, in particular, the generation of this analog data stream, exhibits substantial disadvantages.

Thus, in step S4 shown in FIG. 4c an interpolation is achieved by virtue of the fact that zeros are inserted into the discrete, digital data stream. A substantial disadvantage of inserting “zeros” consists in that so-called image frequencies occur as spectral effects of inserting zeros, that is to say a base spectrum is imaged with reference to the higher sampling rate. It is true that subsequent lowpass filtering, which is conventionally provided in the data stream transmitter, does reduce these image frequencies, but they are nevertheless still present because they cannot really be removed in principle.

Inexpediently, these image frequencies also cannot be removed with the aid of very steep-sided lowpass filter units. Consequently, during a decimation corresponding to the interpolation, in the data stream receiver the remaining, nonfiltered image components are folded into the baseband and disadvantageously appear there as an additional interference source which reduces the achievable data rate.

It is furthermore inexpedient that with many adaptation methods these image frequencies cause a time domain equalizer normally used in the data stream receiver to operate in a nonoptimal fashion.

It is therefore an object of the present invention to further develop a method for transmitting an analog data stream and for conditioning the data stream in the data stream transmitter in such a way that image frequencies are effectively suppressed during decimation carried out in a data stream receiver.

This object is achieved according to the invention by means of a method for transmitting an analog data stream according to patent claim 1, and by means of a circuit arrangement having the features of patent claim 6.

An essential idea of the invention consists in coded data blocks which are generated by means of a coding device from data to be transmitted being inversely transformed from the frequency domain into the time domain in conjunction with a number of carriers increased by comparison with a conventional ADSL Standard in an inverse transformation device of the data stream transmitter.

One advantage of the method according to the invention consists in that image frequencies which can be removed with the aid of low-order lowpass filtering devices only occur in a high frequency domain.

Furthermore, it is an advantage that complexity in the implementation of the interpolation path is reduced by using lower-order lowpass filters.

It is advantageous, furthermore, that in the case of lower-order lowpass filters in the data stream receiver time domain equalizers deliver better results.

The method according to the invention for transmitting an analog data stream from a data stream transmitter to a data stream receiver essentially has the following steps:

a) providing data to be transmitted;

b) interpolating the data to be transmitted in an interpolation device of the data stream transmitter, in order to provide an interpolation between successive samples of a supplied multitone signal,

coded data blocks which are generated by means of a coding device from the data to be transmitted being inversely transformed from the frequency domain into the time domain in conjunction with a number of carriers, increased by comparison with an ADSL Standard in an inverse transformation device of the data stream transmitter.

Advantageous developments and improvements of the respective subject matter of the invention are to be found in the subclaims.

In accordance with a preferred development of the present invention, switching into an operating mode having a number of carriers increased by comparison with the ADSL Standard has the effect that coded data blocks which are generated by means of the coding device from the data to be transmitted are inversely transformed from the frequency domain into the time domain in conjunction with the increased number of carriers, only a prescribable number of carriers being used.

In accordance with a further preferred development of the present invention, a number of carriers in an inverse transformation is doubled by comparison with an inverse transformation in accordance with a conventional ADSL Standard. It is true that this requires an IFFT (inverse transformation device) with twice as many carriers in order to generate the time signal, the upper carriers being set to zero, that is to say use is made of 64 carriers, for example, the carriers numbers 33 to 64 being set to zero, but the image frequencies expediently do not occur until in a much higher frequency domain.

In accordance with a further preferred development of the present invention, it is possible to use low-order lowpass filters. This advantage has an effect, in particular, on a reduced complexity of the implementation of the interpolation path and an achievable data rate.

In accordance with yet a further preferred development of the present invention, the carriers numbers 33 to 64 are set to zero.

The circuit arrangement according to the invention for transmitting an analog data stream composed of discrete multitone symbols from a data stream transmitter to a data stream receiver via a transmission channel further has:

a) a coding device for coding data to be transmitted;

b) an inverse transformation device which is operated with an increased number of carriers;

c) a digital-to-analog converter for converting the inversely transformed digital transmitter signal into an analog transmitter signal; and

d) an interpolation device which carries out an interpolation without inserting zeros.

The data stream transmitter advantageously contains a lower-order lowpass filtering device.

Preferred exemplary embodiments of the invention are illustrated in the drawings and explained in more detail in the following description.

In the drawings:

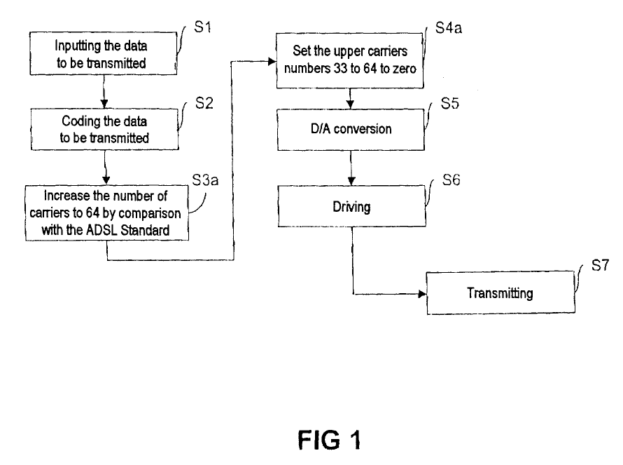

FIG. 1 shows a flowchart of the method according to the invention for transmitting an analog data stream, in the case of which a number of carriers of the inverse transformation device is increased in the data stream transmitter;

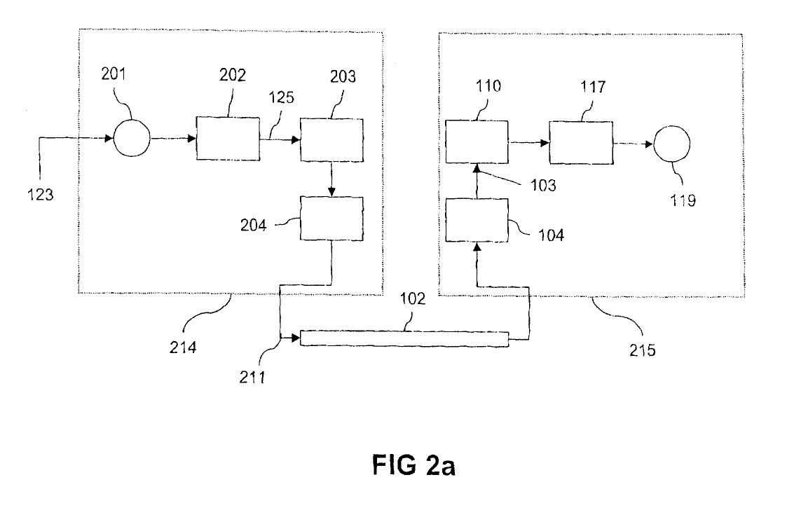

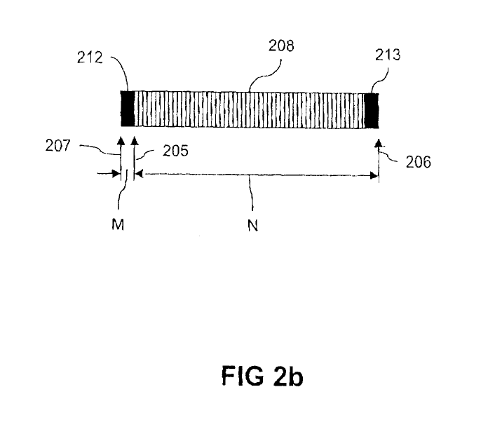

FIG. 2a shows a block diagram of a transmission link for multitone symbols, having a data stream transmitter, transmission channel and data stream receiver;

FIG. 2b shows a schematic design of a multitone symbol with cyclic prefix;

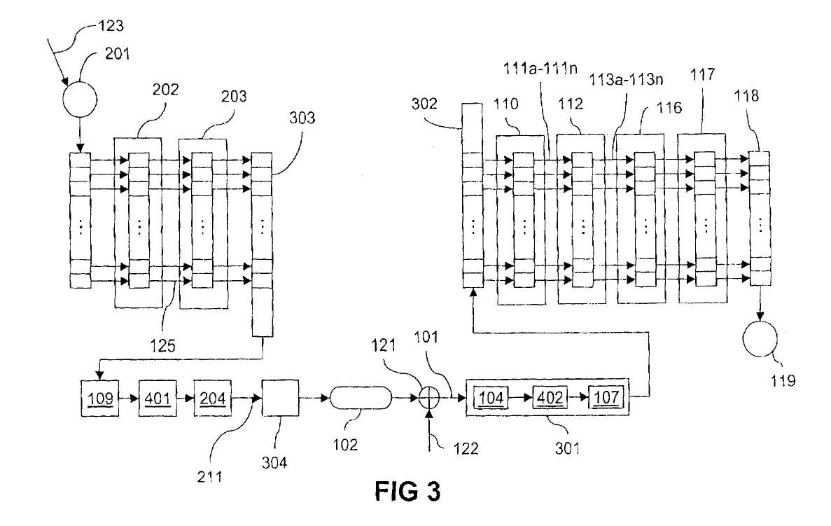

FIG. 3 shows the circuit arrangement illustrated in FIG. 2a for transmitting an analog data stream, as a total link in a detailed illustration;

FIG. 4 shows a data stream transmitter according to the prior art;

FIG. 4a shows a detail of a block diagram of a conditioning of a data stream to be transmitted composed of a multitone signal by means of an interpolation device, a transmitter filtering device and a digital-to-analog converter according to the prior art;

FIG. 4b shows a detail of a block diagram of a preprocessing device of a data stream receiver in which received data are converted into a preprocessing digital data stream, having an analog-to-digital converter, a receiver filtering device and a decimation device; and

FIG. 4c shows a flowchart of a conventional method for transmitting an analog data stream.

In the figures, identical reference symbols denote identical or functionally identical components or steps.

FIG. 2a shows a fundamental block diagram of an arrangement for transmitting an analog data stream using the DMT method, the data stream transmitter 214, the transmission channel 102 and the data stream receiver 215 being illustrated.

A data stream transmitter 214 and a data stream receiver 215 respectively comprise separately identifiable blocks which are briefly described below. A data input device 201 serves for inputting data to be transmitted, the input data being forwarded to a coding device 202. The data stream is decoded in the coding device 202 in accordance with a conventional method and supplied to an inverse transformation device 203.

The inverse transformation device 203 provides a transformation of the data present in the frequency domain into data which are present in the time domain. The inverse transformation device 203 can be provided, for example, by a device in which an inverse fast Fourier transformation (IFFT) is carried out.

It may be pointed out that the transformation carried out in the inverse transformation device 203 from the frequency domain into the time domain constitutes a transformation inverse to that transformation which is carried out by a transformation device 110 in the data stream receiver 215.

Finally, the digital data stream output by the inverse transformation device 203 is converted into an analog data stream by means of a digital-to-analog converter 204. The analog data stream now present in the time domain is supplied to a transmission channel 102 which provides the above-described data transmission, it being possible for bandpass, highpass and/or lowpass filtering and application of noise to the analog data stream 101 to be present in a transmission. The analog data stream 101 is further supplied to the analog-to-digital converter 104 which is arranged in the data stream receiver 215 and converts the received analog data stream 101 into a digital data stream 103, the converted digital data stream 103 being supplied to the transformation device 110.

After a transformation from the frequency domain into the time domain that is inverse relative to that in the inverse transformation device 203, a decoding is performed in the decoding device 117 after the transformed data stream transverses a correction device (not shown) and a determination device (not shown). The decoded data stream is finally output via the data output device 119.

A diagram of a discrete multitone symbol is shown in FIG. 2b, the analog data stream to be transmitted being provided as a sequence of multitone symbols 208. Before the data transformed in the inverse transformation device 203 are forwarded to the digital-to-analog converter 204, the last M samples of a multitone symbol are once again appended to the block start, a cyclic prefix being defined, and it being valid that:

M<N.

It is possible in this way for a periodic signal to be simulated to a data stream receiver when the transient phenomenon caused by the transmission channel has decayed after M samples, that is to say no intersymbol interference (IST) occurs.

As shown in FIG. 2b, the original multitone symbol has a length of N samples, for example N=64, while the last four values, for example, are set as a cyclic prefix 212 at the DMT symbol beginning 205, the following being valid:

M=4.

Together with the DMT symbol end values 213 appended to the symbol beginning 205, the total length of a multitone symbol 208 is now M+N from the prefix beginning 207 up to the DMT symbol end 206.

It may be pointed out that the number of the DMT symbol end values 213 appended cyclically to the symbol beginning 205 must be kept as low as possible, that is to say M<<N, in order to cause the smallest possible reduction in the transmission capacity and transmission quality.

In a further example, a multitone symbol 208 consists of 256 complex numbers, which means that 512 time samples (real and imaginary parts) must be transmitted as a periodic signal. In this example, if a number of 32 DMT symbol end values 213 are copied as cyclic prefix 212 at the symbol beginning, calculation yields a total length of the time sample to be transmitted of 544, something which yields a sampling time T_{A} of 544×10⁻⁶/2.208 seconds or 0.25 ms given a maximum tone frequency of 2.208 MHz for a DMT signal, the symbol transmission frequency being calculated from f_{DMT}=1/T_{A}≈4 kHz.

A circuit arrangement for transmitting an analog data stream 101 is shown in a detailed illustration in FIG. 3.

The data stream supplied to the data input device 201, that is to say the data 123 to be transmitted, are combined into blocks, a specific number of bits to be transmitted being assigned to a complex number, depending on scaling. Finally, coding is performed in the coding device 202 in accordance with the selected scaling, the coded data stream finally being supplied to the inverse transformation device 203.

A multitone signal 303 provided by the inverse transformation device 203 finally forms a digital transmitter data stream which has been transformed from the frequency domain into the time domain. Finally, after interpolation in an interpolation device 109 and filtering in a transmitter filtering device 401, the multitone signal 303 constructed as digital data stream is converted in the digital-to-analog converter 204 into an analog data stream which is supplied, in turn, to a line driver device 304.

The line driver device 304 amplifies or drives the analog data stream 101 to be transmitted into a transmission channel 102 whose channel transmission function is known in principle or can be measured.

Furthermore, a superimposition of the analog data stream by noise takes place in the transmission channel, something which is illustrated in FIG. 3 by a superimposition device 121. The superimposition device 121 is supplied with the analog data stream transmitted by the transmission channel and with a noise signal 122 so that, finally, an analog data stream 101 superimposed by noise is obtained.

The analog data stream 101 is supplied to the preprocessing device 301 of the data stream receiver in which in essence analog-to-digital conversion, filtering and subsequent decimation of the analog data stream are provided. The circuit components which are required for such preprocessing of received data 403 are described above with reference to FIG. 4b. The preprocessing device 301 uses the received analog data stream 101 to generate a preprocessed digital data stream 302 which is supplied in the data stream receiver to a transformation device 110.

The transformation device 110 provides a transformation of the decimated equalized digital data stream into transformation signals 111a-111n, n being the maximum number, in this example 256, of the cosinusoidal or sinusoidal signals defined in absolute value and phase. It may be pointed out that the transformation device 110 undertakes digital transformation of a signal present in digital form in the time domain into a signal which is present in digital form in the frequency domain.

The transformation signals 111a-111n correspond, for example, to complex numbers for each of the multitones, an evaluation in absolute value and phase or in real part and imaginary part being provided. Furthermore, the complex numbers can be provided as amplitudes of cosinusoidal oscillations (real part) and sinusoidal oscillations (imaginary part) which are to be emitted in a block, the frequencies being provided in a fashion distributed equidistantly in accordance with the equation specified above, the data to be transmitted being combined in blocks.

It may be pointed out that more or less than 256 different tones can be transmitted as cosinusoidal or sinusoidal signals which are defined in absolute value and phase and can be modulated, a correspondingly different number of transformation signals 111a-111n being produced. In this case, the first transformation signal is denoted as 111a, and the last transformation signal as 111n. The transformation device 110 preferably carries out a fast Fourier transformation (FFT), in order to provide a fast transformation from the time domain into the frequency domain.

In an adjoining correction device 112, the transformation signals 111a-111n are weighted with the aid of a known correction function which is prescribed for the correction device 112. Preferably, but not exclusively, this correction function, which is prescribed for the correction device 112, is an inverse of the channel transmission function of the transmission channel 102. In this way, influences of the transmission channel can be compensated with regard to frequency response, phase, etc., such that corrected transformation signals 113a-113n are obtained at the output of the correction device 112.

The corrected transformation signals 113a-113n are subsequently supplied to a determination device 116 in which at least one absolute-value signal 114 and at least one phase signal 115, respectively a real part and an imaginary part of a corrected transformation signal, is determined.

It may be pointed out that the corrected transformation signals can be equalized both in the time domain by means of a time domain equalizer (not shown), and in the frequency domain by means of the correction device 112, the time domain equalizer providing time domain equalization, while the correction device 112 provides frequency domain equalization.

The absolute-value signals 114 and phase signals 115 determined in the determination device 116 are subsequently decoded by supplying the absolute-value signals 114 and the phase signals 115 to a decoding device 117.

A decoding in accordance with the data stream is provided in the decoding device 117. Thus, the decoding device 117 provides a decoded data stream 118 that is finally supplied to a data output device 119 and can be output from there and further processed.

The method according to the invention is explained as illustrated in FIG. 1.

As already mentioned with reference to FIG. 2a and FIG. 3, after inputting of the data stream to be transmitted in a step S1, the data are coded in a coding device (step S2).

According to the invention, a number of carriers in an inverse transformation device is increased, here by the factor 2, for example, as illustrated in step S3a.

In the preferred exemplary embodiment of the present invention, switching into an operating mode with a number of carriers increased by comparison with the ADSL Standard has the effect that coded data blocks that are generated by means of the coding device from the data to be transmitted are inversely transformed from the frequency domain into the time domain in conjunction with the increased number of carriers, only a prescribable number of carriers being used.

In this exemplary embodiment, the number of carriers is 32, and so the carriers 33 to 64 are set to zero in an ADSL Standard after doubling of the number of carriers to 64 (step S4a).

As in the case of conventional methods, a digital-to-analog conversion is subsequently performed in step S5, whereupon the analog data stream is driven (step S6) for transmission, carried out in step S7, via the transmission channel 102.

As already mentioned, in order completely to eliminate the image frequency components produced in the case of interpolation, that is to say in order to provide decimation to the symbol rate in the data stream receiver without convolutional products, the time signal to be transmitted is generated in DMT systems by means of an IFFT (Inverse Fast Fourier Transformation), the number of the carriers being defined in the appropriate standard (for example 32 for the ADSL upstream channel), the uppermost carrier having a frequency of 138 kHz. In this case, image components occur starting from a frequency of 138 kHz in the case of conventional methods.

In order to achieve spectral separation, an IFFT with, for example, twice as many carriers is provided for generating the time signal, the highest (uppermost) carriers being set to zero. In this example (that is to say the example with 64 carriers), the carriers numbers 33 to 64 (the uppermost carriers) are set to zero. In this way, image frequencies occur only from a frequency of 414 kHz which can advantageously be eliminated with the aid of low-order lowpass filters.

Thus, it is advantageously possible for a lowpass filter 402 of a low order to be used in the data stream receiver 215, and this considerably reduces an outlay on implementation for the overall data transmission system.

Reference is made to the introduction to the description in respect of the circuit arrangements illustrated in FIGS. 4a-4c and methods for transmitting an analog data stream.

Although the present invention has been described above with the aid of preferred exemplary embodiments, it is not limited thereto, but can be modified in multifarious ways.

Again, the invention is not limited to the said possible applications.

1. Method for transmitting an analog data stream (101), which is composed of discrete multitone symbols (208), from a data stream transmitter (214) via a transmission channel (102) to a data stream receiver (215), interpolation between successive samples of a supplied multitone signal (303) being carried out in an interpolation device (109) of the data stream transmitter (214), characterized in that coded data blocks (125) which are generated by means of a coding device (202) from data (123) to be transmitted are inversely transformed from the frequency domain into the time domain in conjunction with an increased number of carriers in an inverse transformation device (203) of the data stream transmitter (214).

2. Method according to claim 1, characterized in that switching into an operating mode having a number of carriers increased by comparison with the ADSL Standard is carried out in such a way that the coded data blocks (125) which can be generated by means of the coding device (202) from the data to be transmitted are inversely transformed from the frequency domain into the time domain in conjunction with the increased number of carriers.

3. Method according to claim 1, characterized in that a number of carriers in the inverse transformation is doubled by comparison with an inverse transformation in accordance with an ADSL Standard.

4. Method according to claim 1, characterized in that low-order lowpass filters can be used in the data stream transmitter (214) and/or the data stream receiver (215).

5. Method according to claim 1, characterized in that the upper carriers are set to zero in the inverse transformation.

6. Circuit arrangement for transmitting an analog data stream (101), which is composed of discrete multitone symbols (208), from a data stream transmitter (214) via a transmission channel (102) to a data stream receiver (215), interpolation between successive samples of a supplied multitone signal (303) being carried out in an interpolation device (109) of the data stream transmitter (214), characterized in that the data stream transmitter has:
a) a coding device (202) for coding a supplied digital data stream;
b) an inverse transformation device (203) for reconverting from a frequency domain into a time domain in conjunction with an increased rate of carriers; and
c) a digital-to-analog converter (204) for converting the digital data stream inversely transformed into the time domain into an analog data stream (101).

7. Circuit arrangement according to claim 6, characterized in that the data stream transmitter (214) has a low-order receiver filtering device (402).

8. Circuit arrangement according to claim 6, characterized in that the receiver filtering device (402) is constructed as a lowpass filter.
